(19) United States
(12) Patent Application Publication
(10) Pub. No.: US 2007/0165262 A1
(43) Pub. Date: Jul. 19, 2007

(54) IMAGE PROCESSING APPARATUS AND OPERATION MODE SWITCHING CONTROL METHOD FOR THE SAME

(75) Inventors: Hiroshi Watanabe, Kanagawa-ken (JP); Takao Iwasaki, Tokyo (JP); Beniko Matsumoto, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/622,218

(22) Filed: Jan. 11, 2007

(30) Foreign Application Priority Data
Jan. 16, 2006 (JP) 2006-007515

(51) Int. Cl. G06F 3/12; G06K 15/00

(52) U.S. Cl. 358/1.14; 358/1.13

(57) ABSTRACT

To provide an image processing apparatus for switching an operation mode between an ordinary power supplying mode and a power saving mode for suppressing power consumption more than the ordinary power supplying mode. The image processing apparatus includes an operation panel operated by a user to execute an operation of the image processing apparatus, a display unit to display a state of the image processing apparatus and various instructions to the user on the operation panel, a discrimination information obtaining unit to obtain a user discrimination information from a non-contact medium in which the user discrimination information is stored to permit use of the image processing apparatus, an information discrimination unit to discriminate approval or disapproval of use of the image processing apparatus from the user discrimination information obtained by the discrimination information obtaining unit, an operation mode discrimination unit to discriminate whether the operation panel is operated and the operation mode of the image processing apparatus is switched from the power saving mode to the ordinary power supplying mode or not, and a control unit to control the display unit to display that the use of the image processing apparatus is permitted when the operation mode discrimination unit discriminates that the operation mode of the image processing apparatus is switched to the ordinary power supplying mode after the image processing apparatus obtains the user discrimination information from the discrimination information obtaining unit on the power saving mode and when the information discrimination unit discriminates that the image processing apparatus is permitted to use.

### CROSS-REFERENCE TO RELATED APPLICATION

This application is based upon and claims the benefit of priority from the prior Japanese Patent Application No. 2006-7515 filed on Jan. 16, 2006, the entire contents of which are incorporated herein by reference.

### BACKGROUND

1. Field of the Invention

The present invention relates to an image processing apparatus for performing management concerning a predetermined process executed in the image processing apparatus capable of switching an operation mode and an operation mode switching control method for the image processing apparatus.

2. Description of the Related Art

Conventionally, in an image processing apparatus for forming an image on a sheet and reading an image of a document, an art for switching an operation mode between an ordinary power supplying mode and a power saving mode (the so-called sleep mode) for suppressing power consumption more than the ordinary power supplying mode is known. Further, in recent years, in such an image processing apparatus, as disclosed in Japanese Patent Application Publication No. 2003-195986 and Japanese Patent application Publication No. 2002-86846, an art for certify a user using a non-contact IC card or a portable terminal is known.

In the image processing apparatus for certifying a user using a non-contact IC card, when the user holds the non-contact IC card storing his ID information over a tag reader installed in the image processing apparatus (brings the non-contact IC card close to a tag reader), the image processing apparatus obtains the information of the non-contact IC card in non-contact. The image processing apparatus obtaining the information for discriminating the user from the non-contact IC card, when the operation mode is set at the power saving mode, switches it to the ordinary power supplying mode and permits the user to use various image processing functions.

In the conventional image processing apparatus for performing the user certification using the aforementioned non-contact IC card, when the image processing apparatus obtains the discrimination information held on the non-contact IC card in the state that the operation is set at the power saving mode, the operation mode is automatically switched to the ordinary power supplying mode and the user certification is completed (the use restriction is canceled).

However, depending on the arrangement condition of the image processing apparatus, when a person not intending to use the concerned image processing apparatus passes in the neighborhood of the image processing apparatus, the image processing apparatus may read by mistake the information of the non-contact IC card held by him.

In such a case, the image processing apparatus aforementioned, when a person only passes in the neighborhood of the concerned image processing apparatus, though he does not intend to use it, completes the certification process of his ID. Therefore, a situation may occur that another person can use the image processing apparatus the use restriction of which is canceled by his ID. Further, when a person not intending to use the concerned image processing apparatus only passes in the neighborhood of the image processing apparatus, the power saving mode is switched to the ordinary power supplying mode, thus a problem arises that power is consumed uselessly.

### SUMMARY

An object of the present invention is to provide an image processing apparatus, performing user certification using a non-contact medium and switching an operation mode, for suppressing an occurrence of a harmful effect due to accidentally reading a non-contact medium held by a user by the image processing apparatus and an operation mode switching control method for the image processing apparatus.

According to an aspect of the present invention, there is provided an image processing apparatus for switching an operation mode between an ordinary power supplying mode and a power saving mode for suppressing power consumption more than the ordinary power supplying mode comprising an operation panel operated by a user to execute an operation of the image processing apparatus; a display unit to display a state of the image processing apparatus and various instructions to the user on the operation panel; a discrimination information obtaining unit to obtain a user discrimination information from a non-contact medium in which the user discrimination information is stored to permit use of the image processing apparatus; an information discrimination unit to discriminate approval or disapproval of use of the image processing apparatus from the user discrimination information obtained by the discrimination information obtaining unit; an operation mode discrimination unit to discriminate whether the operation panel is operated and the operation mode of the image processing apparatus is switched from the power saving mode to the ordinary power supplying mode or not; and a control unit to control the display unit to display that the use of the image processing apparatus is permitted when the operation mode discrimination unit discriminates that the operation mode of the image processing apparatus is switched to the ordinary power supplying mode after the image processing apparatus obtains the user discrimination information from the discrimination information obtaining unit on the power saving mode and when the information discrimination unit discriminates that the image processing apparatus is permitted to use.

Furthermore, according to an aspect of the present invention, there is provided an operation mode switching control method for an image processing apparatus having an operation panel and a display unit for switching an operation mode between an ordinary power supplying mode and a power saving mode for suppressing power consumption more than the ordinary power supplying mode comprising accepting an operation of the operation panel to execute an operation of the image processing apparatus; displaying a state of the image processing apparatus and various instructions to a user on the display unit; obtaining a user discrimination information from a non-contact medium in which the user discrimination information is stored to permit use of the image processing apparatus; discriminating approval or disapproval of use of the image processing apparatus from the user discrimination information obtained; discriminating whether the operation mode of the image processing apparatus is switched from the power saving mode to the ordinary power supplying mode or not by the acceptance of the operation from the operation panel; and displaying on the display unit that the use of the image processing apparatus is permitted when the operation mode of the image processing apparatus is switched to the ordinary power supplying mode after the image processing apparatus obtains the user discrimination information on the power saving mode and when the image processing apparatus is permitted to use.

### BRIEF DESCRIPTION OF THE DRAWINGS

FIG. 1 is a function block diagram for explaining the image processing apparatus of this embodiment;

FIG. 2 is a plan view showing the operation panel of the image processing apparatus of this embodiment;

FIG. 3 is a schematic view showing the situation that a non-contact IC card is held over the card reader;

FIG. 4 is a plan view showing the display of the operation panel for displaying a message for instructing to hold the non-contact IC card over the card reader and touch panel;

FIG. 5 is a plan view showing the display of the operation panel and touch panel showing an illustration;

FIG. 6 is a plan view showing the touch panel of the operation panel for displaying a message indicating the power saving state;

FIG. 7 is a flow chart showing the operation flow of the image processing apparatus in the ordinary power supplying mode; and

FIG. 8 is a flow chart showing the operation flow of the image processing apparatus in the power saving mode.

### DETAILED DESCRIPTION

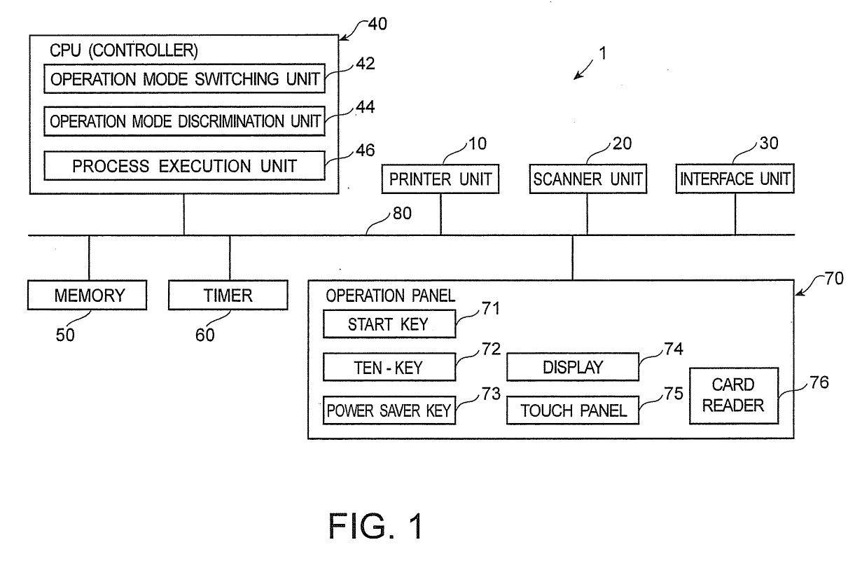

The embodiment of the present invention will be explained below with reference to the accompanying drawings. FIG. 1 is a function block diagram for explaining an image processing apparatus (MFP: multi function peripheral) 1 of this embodiment. The image processing apparatus 1 of this embodiment can switch the operation mode between the “ordinary power supplying mode” and the “power saving mode” for suppressing power consumption more than the ordinary power supplying mode.

As shown in FIG. 1, the image processing apparatus 1 of this embodiment is composed of a printer unit 10, a scanner unit 20, an interface unit 30, a controller 40, a memory 50, a timer 60, and an operation panel 70 and these units are mutually connected via a bus 80.

The controller 40 is composed of an operation mode switching unit 42, an operation mode discrimination unit 44, and a process execution unit 46.

The operation panel 70 is installed on the top of the main unit of the processing apparatus 1 so as to be operated by a user. The operation panel 70 includes a start key 71 pressed by the user so as to execute printing, a ten-key pad 72 for setting the number of printed copies and others, and a power saver key 73 pressed to switch the processing apparatus 1 to the power saving mode. Further, the operation panel 70 includes a display 74 for displaying the state of the processing apparatus 1 and various instructions to the user in characters and illustrations and a touch panel 75 for inputting a user instruction to the processing apparatus 1 by touching a displayed character or illustration. Furthermore, on the operation panel 70, a card reader 76 to which a non-contact IC card A possessed by the user is brought close is arranged.

The card reader 76 as a discrimination information obtaining unit reads the information stored in the non-contact IC card A as a non-contact medium possessed by the user. The card reader 76 obtains, from the non-contact IC card A storing discrimination information (user ID, etc.) to discriminate the user, the concerned discrimination information.

The operation mode switching unit 42, on the basis of the operation input (touching the touch panel 75 or pressing a key) to the operation panel 70, switches the operation mode of the image processing apparatus 1. The operation mode switching unit 42, when the image processing apparatus 1 is in the ordinary power supplying mode, if there is no operation input for a predetermined period of time (for example one minute) or more, automatically switches the operation mode to the power saving mode. The timer 60 counts the predetermined period of time. The operation mode switching unit 42, when the image processing apparatus 1 is in the power saving mode, if there is input from the operation panel 70, switches the operation mode to the ordinary power supplying mode. Further, in the power saving mode, generally, the power supply to a fixing device (not drawn) of the printer unit 10 is stopped or the supply power is reduced.

Further, the power saving mode includes two states. One of them is called a “low power mode” and when the timer 60 counts the predetermined period of time after the last use of the image processing apparatus 1, the operation mode is moved to the low power mode. In the low power mode, on the display 74 of the operation panel 70, “Power Saving Mode! Please Press the Start key” is displayed. Further, in the low power mode, the power supply to the fixing device (not drawn) installed in the printer unit 10 is not stopped but the fixing device is kept at a predetermined temperature and when the low power mode is canceled, it is set so as to reach a fixable temperature within a predetermined period of time. The other one is called a “sleep mode” and when the timer 60 counts the predetermined period of time after the last use of the image processing apparatus 1, the operation mode is moved to the sleep mode. In the sleep mode, the display on the display 74 of the operation panel 70 disappears and the power saver key 73 lights. During the power saving, when the image processing apparatus 1 receives print data, facsimile, internet facsimile, or E mail, the power saving mode is canceled. When the start button is pressed, the power saving mode is canceled. Further, by touching the touch panel 75, the power saving mode is not canceled. Further, in the sleep mode, no power is supplied to the fixing device.

The operation mode discrimination unit 44 discriminates which one is the operation mode of the image processing apparatus 1, the ordinary power supplying mode or the power saving mode.

The process execution unit 46, on the basis of the discrimination information obtained by the card reader 76, executes the user certification process and a predetermined process such as start of the printer unit 10 or scanner unit 20 according to acquisition of the discrimination information.

The memory 50 is composed of, for example, an HDD or a RAM and stores discrimination information obtained by the card reader 76.

The process execution unit 46, on the basis of the discrimination information obtained by the card reader 76, executes the user certification process and a predetermined process such as start of a predetermined unit according to acquisition of the discrimination information.

The operation mode switching unit 42, on the basis of the operation input (touching the touch panel 75 or pressing a button or a key) to the operation panel 70, switches the operation mode of the image processing apparatus 1. The operation mode switching unit 42, when the image processing apparatus 1 is in the ordinary power supplying mode, if there is no operation input for a predetermined period of time or more, automatically switches the operation mode to the power saving mode. The predetermined period of time is counted by the timer 60. The operation mode switching unit 42, when the image processing apparatus 1 is in the power saving mode, if the user executes operation input to the operation panel 70, switches the operation mode to the ordinary power supplying mode.

The controller 40 performs various processes of the image processing apparatus 1. Further, the controller 40 executes programs stored in the memory 50, thereby realizes various functions. The memory 50 is composed of, for example, a ROM or a RAM and stores various information and programs used by the image processing apparatus 1.

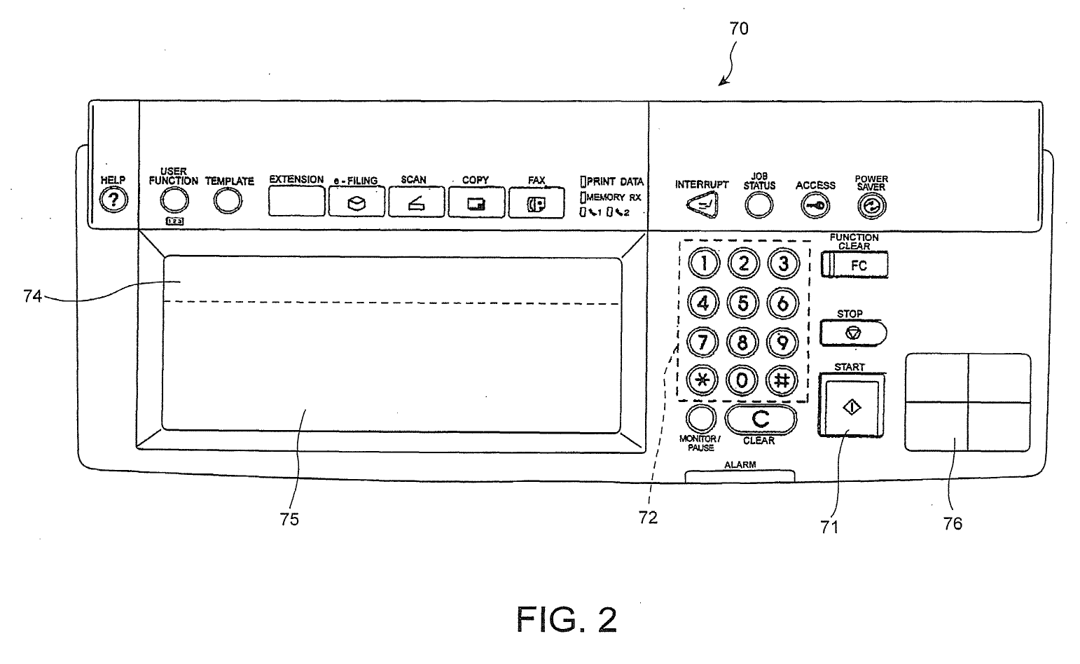

FIG. 2 shows the operation panel 70. The operation panel 70 is composed of the start key 71 pressed to start copying and scanning on the panel body, the ten-key pad 72 pressed to set the number of printed copies and the number of scanned copies, the power saver key 73 pressed to switch the operation mode to the power saving mode, the display 74 for displaying the state of the processing apparatus 1 and various instructions to the user in characters and illustrations, and the touch panel 75 for inputting a user instruction to the processing apparatus 1 by touching a displayed character or illustration. Furthermore, on the operation panel 70, the card reader 76 to which a non-contact IC card A possessed by the user is brought close is arranged. Further, on the operation panel 70, various buttons and keys are installed additionally.

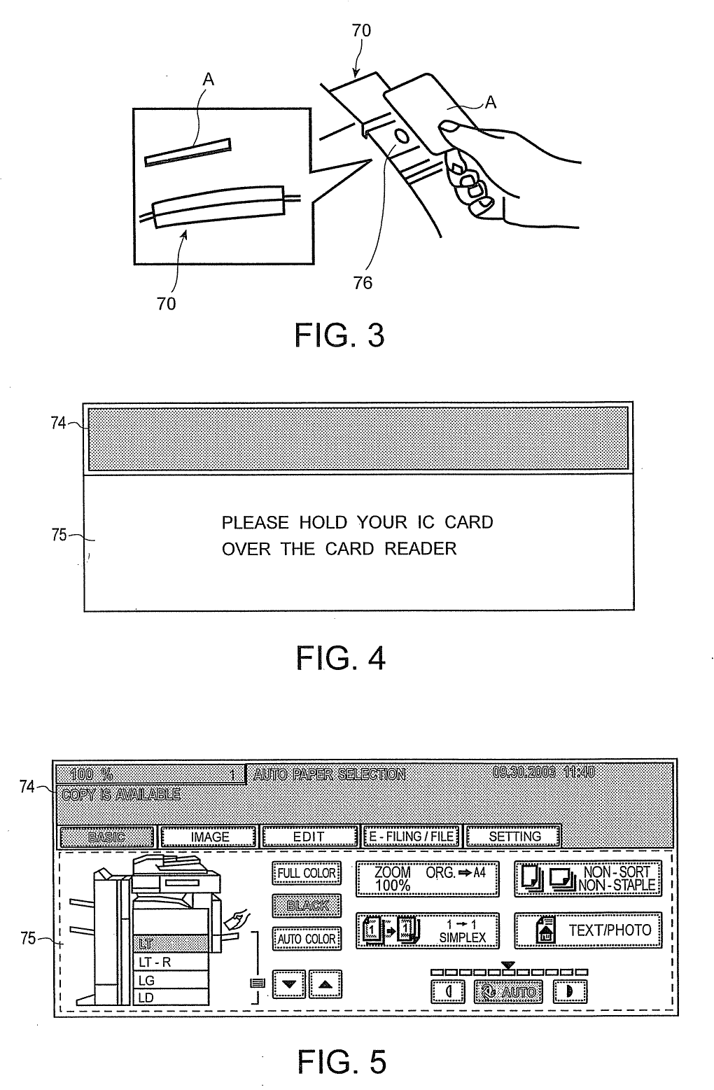

FIG. 3 shows the situation that the non-contact IC card A is held over, that is, is brought close to the card reader 76 installed on the operation panel 70 at a distance of about 4 cm, thus the discrimination information stored in the IC card A is read.

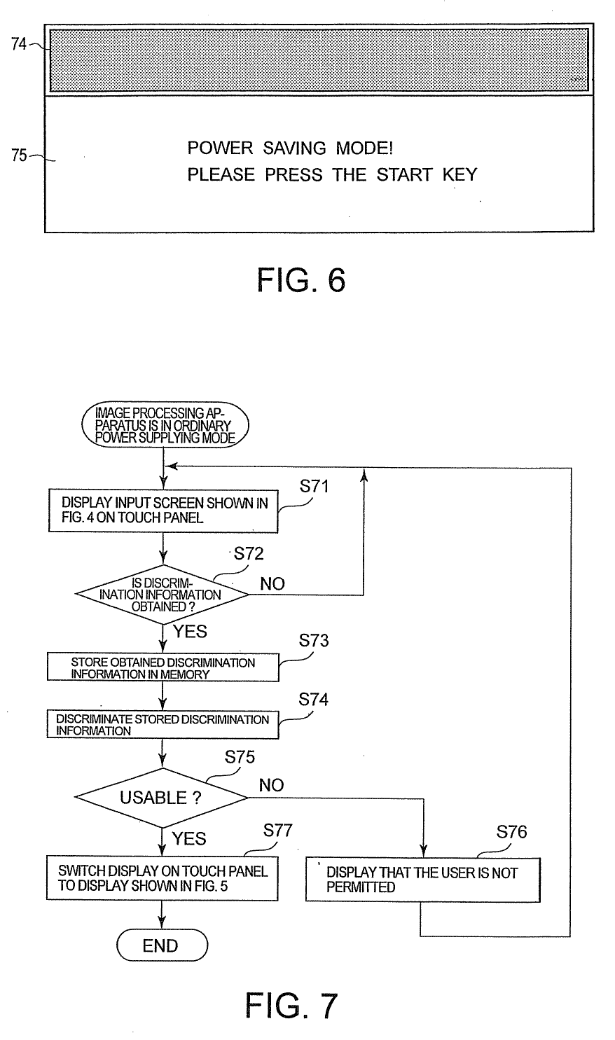

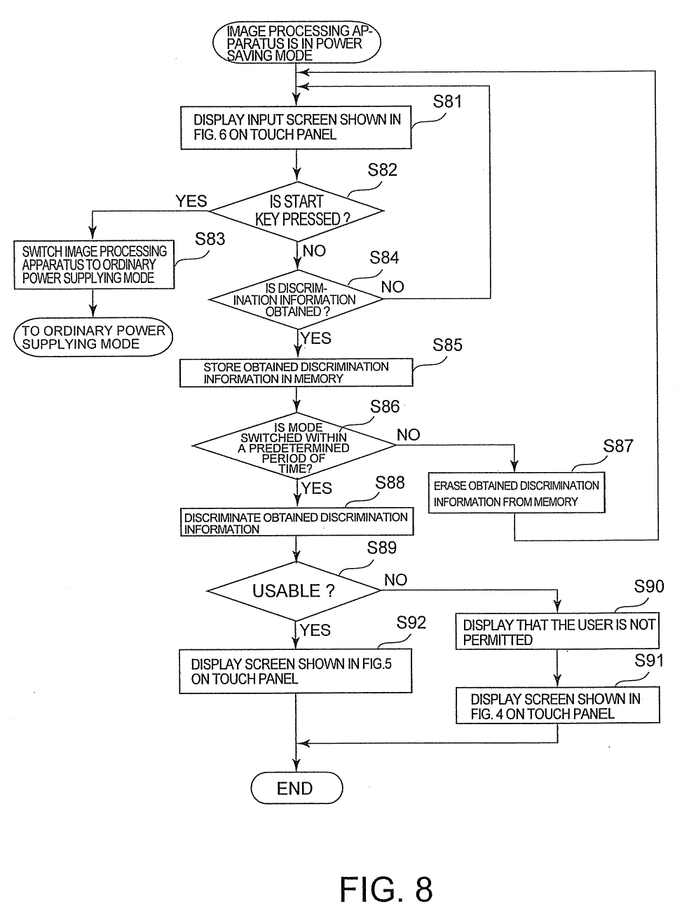

FIG. 4 shows the situation that “Please Hold Your IC Card Over The Card Reader” is displayed on the display 74 installed on the operation panel 70.

FIG. 5 shows the situation that “Copy Is Available” is displayed on the display 74 on the operation panel 70 and characters and an illustration are displayed on the touch panel 75.

FIG. 6 shows the situation that “Power Saving Mode! Please Press The Start Key” is displayed on the touch panel 75.

FIG. 7 is a flow chart showing the processing flow when the image processing apparatus 1 of this embodiment is in the ordinary power supplying mode.

When the power source of the image processing apparatus 1 is turned on and the initialization thereof is finished, on the display 74 or touch panel 75, as shown in FIG. 4, “Please Hold Your IC Card Over The Card Reader” is displayed (Step S71).

The user holds the IC card A over the card reader 76 and the CPU 40 discriminates whether the discrimination information is obtained from the IC card A or not (Step S72). As a result of the discrimination at Step S72, when it is found that the discrimination information is obtained (YES at Step S72), the CPU 40 stores the obtained discrimination information in the memory 50 (Step S73). Then, the CPU 40 discriminates the contents of the discrimination information stored in the memory 50 (Step S74) and as a result of discrimination, whether the user is permitted to use the image processing apparatus 1 or not is discriminated (Step S75). As a result of the discrimination at Step S75, when it is found that the user is not permitted (NO at Step S75), on the display 74 or touch panel 75, “You Are An Unauthorized User, You Cannot Use The Image Processing Apparatus” is displayed (Step S76).

As a result of the discrimination at Step S75, when it is found that the user is permitted (YES at Step S75), on the display 74, as shown in FIG. 5, “Copy Is Available” is displayed and the apparatus enters the input standby state such as a copy operation by the user (Step S77).

FIG. 8 is a flow chart showing the processing flow when the image processing apparatus 1 of this embodiment is in the power saving mode.

When the power source of the image processing apparatus 1 is turned on and the initialization thereof is finished, on the display 74 or touch panel 75, as shown in FIG. 4, “Please Hold Your IC Card Over The Card Reader” is displayed. However, when the image processing apparatus 1 is not operated by the user for a given period of time, the operation mode is switched automatically to the power saving mode. Further, the time when the apparatus is not operated by the user for the given period of time is counted by the timer 60. When the operation mode is switched to the power saving mode, as shown in FIG. 6, “Power Saving Mode! Please Press The Start Key” is displayed (Step S81).

When the start key 71 is pressed (YES at Step S82), the image processing apparatus 1 is switched to the ordinary power supplying mode (Step S83). When the start key 71 is not pressed (NO at Step S82), the user holds the IC card A over the card reader 76 and the CPU 40 discriminates whether the discrimination information is obtained from the IC card A or not (Step S84). When the discrimination information is obtained (YES at Step S84), the CPU 40 stores the obtained discrimination information in the memory 50 (Step S85). At this time, the touch panel 75 may keep the display shown in FIG. 6 or may display a message for urging the user to operate any key. Further, when the touch panel 75 is touched by the user, the power saving mode may be switched to the ordinary power supplying mode. When the discrimination information is not obtained (NO at Step S84), the operation mode is continued to the power saving mode, as shown in FIG. 6, “Power Saving Mode! Please Press The Start Key” being displayed (Step S81).

Then, when the user presses the start key 71 or any other key within a predetermined period of time, whether the power saving mode is switched to the ordinary power supplying mode or not is discriminated by the operation mode discrimination unit 44 of the CPU 40 (Step S86). When the mode is not switched even if a predetermined period of time elapses after the discrimination information is obtained at Step S85 (NO at Step S86), the operation mode discrimination unit 44 erases the obtained information from the memory 50 (Step S87). After the obtained information is erased from the memory 50, “Power Saving Mode! Please Press The Start Key” is displayed as shown in FIG. 6 (Step S81).

When it is discriminated that the power saving mode is switched to the ordinary power supplying mode (YES at Step S86), the operation mode discrimination unit 44 discriminates the contents of the obtained information (Step S88). As a result of the discrimination at Step S88, whether the user is permitted to use the image processing apparatus 1 or not is discriminated (Step S89). As a result of the discrimination at Step S89, when it is found that the user is not permitted (NO at Step S89), on the display 74 or touch panel 75, “You Are An Unauthorized User. You Cannot Use The Image Processing Apparatus” is displayed (Step S90). Then, on the display 74 or touch panel 75, as shown in FIG. 4, “Please Hold Your IC Card Over The Card Reader” is displayed (Step S91).

As a result of the discrimination at Step S89, when it is found that the user is permitted (YES at Step S89), on the display 74, as shown in FIG. 5, “Copy Is Available” is displayed and the apparatus enters the input standby state such as a copy operation by the user (Step S92).

According to this embodiment of the present invention, a user intends to use the image processing apparatus 1 and switches the operation mode to the ordinary power supplying mode by operation input to the operation panel 70, and then when another user passes in the neighborhood of the image processing apparatus 1, a situation that the information of the non-contact IC card A possessed by the concerned another user is obtained by mistake can be avoided.

What is claimed is:

1. An image processing apparatus for switching an operation mode between an ordinary power supplying mode and a power saving mode for suppressing power consumption more than the ordinary power supplying mode comprising:
an operation panel operated by a user to execute an operation of the image processing apparatus;
a display unit to display a state of the image processing apparatus and various instructions to the user on the operation panel;
a discrimination information obtaining unit to obtain a user discrimination information from a non-contact medium in which the user discrimination information is stored to permit use of the image processing apparatus;
an information discrimination unit to discriminate approval or disapproval of use of the image processing apparatus from the user discrimination information obtained by the discrimination information obtaining unit;
an operation mode discrimination unit to discriminate whether the operation panel is operated and the operation mode of the image processing apparatus is switched from the power saving mode to the ordinary power supplying mode or not; and
a control unit to control the display unit to display that the use of the image processing apparatus is permitted when the operation mode discrimination unit discriminates that the operation mode of the image processing apparatus is switched to the ordinary power supplying mode after the image processing apparatus obtains the user discrimination information from the discrimination information obtaining unit on the power saving mode and when the information discrimination unit discriminates that the image processing apparatus is permitted to use.

2. The apparatus according to claim 1, wherein the operation panel includes a key and a touch panel, and the power saving mode is switched to the ordinary power supplying mode when the key is pressed or the touch panel is touched by the user.

3. The apparatus according to claim 1, wherein the control unit controls the display unit to continue displaying that the image processing apparatus operates on the power saving mode when the operation mode discrimination unit discriminates that the operation mode of the image processing apparatus is the power saving mode for a predetermined period of time after the image processing apparatus obtains the user discrimination information from the discrimination information obtaining unit on the power saving mode.

4. The apparatus according to claim 1, wherein the control unit controls the display unit so as to display non-permission for the user when the information discrimination unit discriminates that use of the image processing apparatus is not permitted.

5. The apparatus according to claim 1, wherein the control unit controls so as to erase the user discrimination information obtained by the discrimination information obtaining unit when the operation mode discrimination unit discriminates that the power saving mode remains unchanged even after a predetermined period of time elapses.

6. The apparatus according to claim 1, wherein the non-contact medium includes a non-contact IC card and the discrimination information obtaining unit includes a card reader to read the user discrimination information stored in the non-contact IC card.

7. An image processing apparatus for switching an operation mode between an ordinary power supplying mode and a power saving mode for suppressing power consumption more than the ordinary power supplying mode comprising:
operation means for being operated by a user to execute an operation of the image processing apparatus;
display means for displaying a state of the image processing apparatus and various instructions to the user on the operation means;
discrimination information obtaining means for obtaining a user discrimination information from a non-contact medium in which the user discrimination information is stored to permit use of the image processing apparatus;
information discrimination means for discriminating approval or disapproval of use of the image processing apparatus from the user discrimination information obtained by the discrimination information obtaining means;
operation mode discrimination means for discriminating whether the operation means is operated and the operation mode of the image processing apparatus is switched from the power saving mode to the ordinary power supplying mode or not; and
control means for controlling the display means to display that the use of the image processing apparatus is permitted when the operation mode discrimination means discriminates that the operation mode of the image processing apparatus is switched to the ordinary power supplying mode after the image processing apparatus obtains the user discrimination information from the discrimination information obtaining means on the power saving mode and when the information discrimination means discriminates that the image processing apparatus is permitted to use.

8. The apparatus according to claim 7, wherein the operation means includes a key and a touch panel, and the power saving mode is switched to the ordinary power supplying mode when the key is pressed or the touch panel is touched by the user.

9. The apparatus according to claim 7, wherein the control means controls the display means to continue displaying that the image processing apparatus operates on the power saving mode when the operation mode discrimination means discriminates that the operation mode of the image processing apparatus is the power saving mode for a predetermined period of time after the image processing apparatus obtains the user discrimination information from the discrimination information obtaining means on the power saving mode.

10. The apparatus according to claim 7, wherein the control means controls the display means so as to display non-permission for the user when the information discrimination means discriminates that use of the image processing apparatus is not permitted.

11. The apparatus according to claim 7, wherein the control means controls so as to erase the user discrimination information obtained by the discrimination information obtaining means when the operation mode discrimination means discriminates that the power saving mode remains unchanged even after a predetermined period of time elapses.

12. The apparatus according to claim 7, wherein the non-contact medium includes a non-contact IC card and the discrimination information obtaining means includes a card reader for reading the user discrimination information stored in the non-contact IC card.

13. An operation mode switching control method for an image processing apparatus having an operation panel and a display unit for switching an operation mode between an ordinary power supplying mode and a power saving mode for suppressing power consumption more than the ordinary power supplying mode comprising:
accepting an operation of the operation panel to execute an operation of the image processing apparatus;
displaying a state of the image processing apparatus and various instructions to a user on the display unit;
obtaining a user discrimination information from a non-contact medium in which the user discrimination information is stored to permit use of the image processing apparatus;
discriminating approval or disapproval of use of the image processing apparatus from the user discrimination information obtained;
discriminating whether the operation mode of the image processing apparatus is switched from the power saving mode to the ordinary power supplying mode or not by the acceptance of the operation from the operation panel; and
displaying on the display unit that the use of the image processing apparatus is permitted when the operation mode of the image processing apparatus is switched to the ordinary power supplying mode after the image processing apparatus obtains the user discrimination information on the power saving mode and when the image processing apparatus is permitted to use.

14. The operation mode switching control method according to claim 13, wherein the operation panel includes a key and a touch panel, and the power saving mode is switched to the ordinary power supplying mode when the key is pressed or the touch panel is touched by the user.

15. The operation mode switching control method according to claim 13, wherein the displaying is continued that the image processing apparatus operates on the power saving mode when the operation mode of the image processing apparatus is the power saving mode for a predetermined period of time after the image processing apparatus obtains the user discrimination information on the power saving mode.

16. The operation mode switching control method according to claim 13, wherein when it is discriminated that use of the image processing apparatus is not permitted, non-permission is displayed on the display unit for the user.

17. The operation mode switching control method according to claim 13, further comprising:
erasing the user discrimination information obtained when the power saving mode remains unchanged even after a predetermined period of time elapses.

18. The operation mode switching control method according to claim 13, wherein the non-contact medium includes a non-contact IC card and the user discrimination information stored in the non-contact IC card is read by a card reader.
